(19) United States
(12) Patent Application Publication
(10) Pub. No.: US 2005/0057049 A1
(43) Pub. Date: Mar. 17, 2005

(54) Break-prevention structure of outside vehicle door handle

(76) Inventor: Dong-Wuk Choi, Gyeonggi-do (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,248

(22) Filed: Dec. 30, 2003

(30) Foreign Application Priority Data
Sep. 16, 2003 (KR) 10-2003-0064065

(51) Int. Cl. E05B 3/00

(52) U.S. Cl. 292/336.3

(57) ABSTRACT

A break-prevention structure of an outside door handle for vehicles has a pivoting portion functioning as a rotating center of a door handle and is prevented from detaching from a handle base by a stopper formed at the pivoting portion of the door handle when the door handle is pulled, thus improving the operation and durability of the outside door handle.

### CROSS-REFERENCE TO RELATED APPLICATIONS

This application claims priority to Korean Application No. 10-2003-0064065, filed on Sep. 16, 2003, the disclosure of which is incorporated fully herein by reference.

### FIELD OF THE INVENTION

Generally, the present invention relates to an outside door handle for vehicles and, more particularly, to a more durable outside door handle having no hinge axle for functioning as a rotating center of a door handle.

### BACKGROUND OF THE INVENTION

Typically, vehicle doors have outside door handles which are affected by the weather and other elements. It is important that outside vehicle door handles have a long durability and a smooth operability suitable for frequent and repeated usage by passengers.

### SUMMARY OF THE INVENTION

Embodiments of the present invention provide a break-prevention structure for outside vehicle door handles for preventing a pivoting portion of an outside door handle from breaking from a handle base and thereby improving the durability of the door handle.

In accordance with a preferred embodiment of the present invention, a break-prevention structure of an outside vehicle door handle comprises a pivoting portion integrally formed at an end of a door handle. The pivoting portion is pivotally inserted into a door handle rotating space formed at one end of a handle base and functions as a rotating center of the door handle. At the other end of the handle base, a handle operating space is formed for receiving a guide portion formed at the other end of the door handle. The pivoting portion is formed with a stopper which protrudes toward the handle base in a vertical direction in relation to the rotating surface of the door handle. The handle rotating space is formed with a stopper groove into which the stopper is inserted.

### BRIEF DESCRIPTION OF THE DRAWINGS

For fuller understanding of the nature and objects of the present invention, reference should be made to the following detailed description taken in conjunction with the accompanying drawings in which:

FIG. 1 is a schematic illustrating an outside door handle according to an embodiment of the present invention;

FIG. 2 is a schematic illustrating a pulled state of the door handle of FIG. 1;

FIG. 3 is a cross-sectional view of the break-prevention structure of an outside vehicle door handle according to an embodiment of the present invention;

FIG. 4 is a rear view of an outside door handle according to an embodiment of the present invention;

FIG. 5 is a schematic illustrating a cut-out handle base for exposing a stopper according to an embodiment of the present invention;

FIG. 6 is a schematic illustrating a stopper groove of the cut-out handle base of FIG. 5;

FIG. 7 is a schematic illustrating a stopper and a stopper groove before a door handle is pulled according to an embodiment of the present invention; and

FIG. 8 is a schematic illustrating a stopper and a stopper groove at the time a door handle is pulled according to an embodiment of the present invention.

### DETAILED DESCRIPTION OF PREFERRED EMBODIMENTS

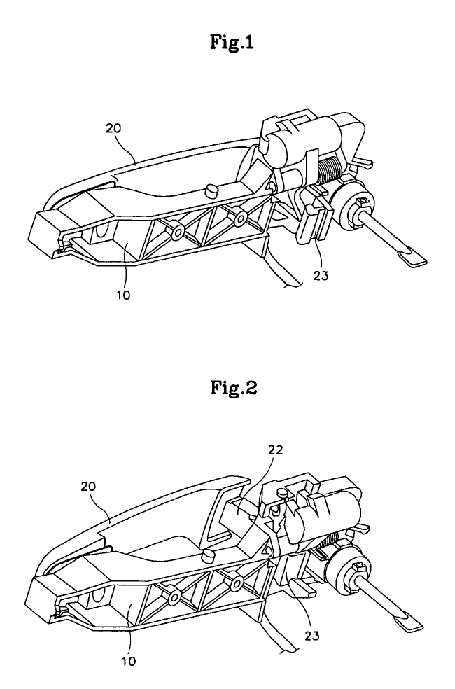

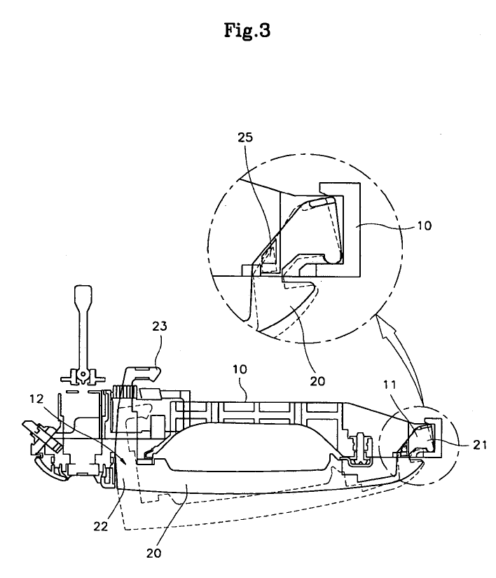

FIGS. 1 and 2 illustrate an outside door handle according to an embodiment of the present invention. When a user pulls a door handle 20 under the FIG. 1 state, the door handle 20 rotates in relation to a handle base 10 as shown in FIG. 2 and latch devices connected to the door handle 20 are activated. As illustrated in FIG. 3, which depicts a cross-sectional view of a coupling relation between the door handle 20 and the door base 10, the door handle 20 is integrally formed at a distal end thereof with a pivoting portion 21, which functions as a rotating center of the door handle 20. The pivoting portion 21 is formed at the other distal end thereof with a rearward-extended guide portion 22 for enabling the door handle 20 to be extracted outside of the handle base 10. The guide portion 22 is formed at a distal end thereof with a hitching portion 23 for preventing the other distal end of the door handle 20 from being detached from the handle base 10.

The handle base 10 is formed at a distal end thereof with a handle rotating space 11 for the pivoting portion 21 of the door handle 20 to be inserted thereinto and to function as a rotating center. The handle base 10 is also formed at the other distal end thereof with a handle operating space 12 for the guide portion 22 of the door handle 20 and the hitching portion 23 to be accommodated thereinto.

The pivoting portion 21 is formed with a stopper 25, which protrudes toward the handle base 10 in a direction perpendicular to the rotating surface of the door handle 20. The handle rotating space 11 is defined with a stopper groove 27 into which the stopper is inserted. The stopper groove 27 is comprised of a radial direction restricting portion 29 for restricting movement of the stopper 25 to a rotating direction of the door handle 20 and a circumferential direction restricting portion 31 for restricting movement of the stopper 25 to a rotating direction of the door handle 20.

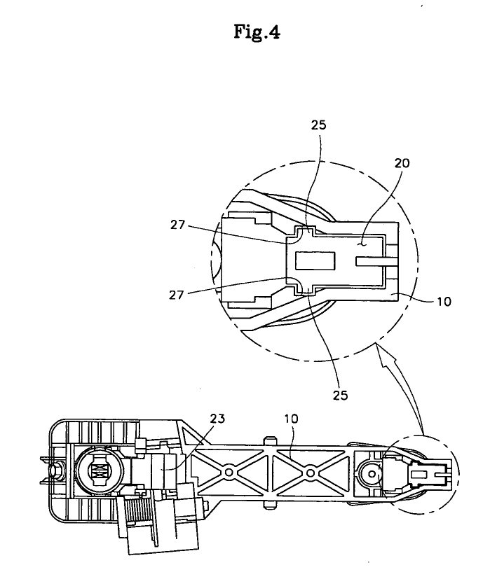

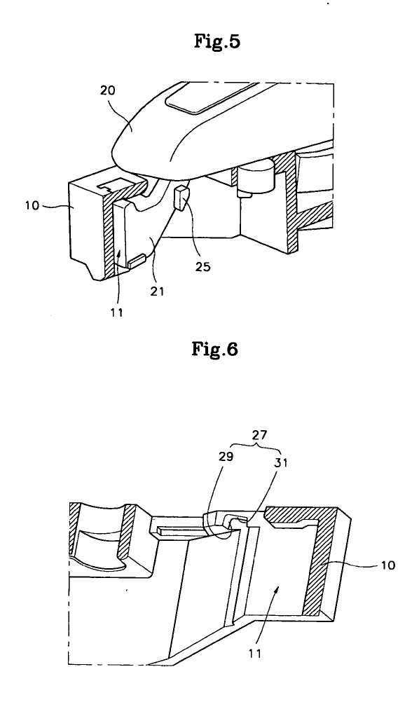

As shown in FIG. 4, two stoppers 25 are disposed, each at an upper surface and a bottom surface of the pivoting portion 21, such that the handle rotating space 11 is formed with two stopper grooves 27 into which said two stoppers 25 can be inserted. FIGS. 5 and 6 respectively illustrate cut-out states of the handle base 10 to expose the stopper 25 and the stopper groove 27.

In the structure thus described, when the door handle 20 is pulled outwards to open the door, the door handle 20 is rotated via the pivoting portion 21 of the door handle 20 inserted into the handle rotating space 11 of the handle base 10 without any separate rotating axle. The other distal end of the door handle 20 is pulled until the guide portion 22 slides into the handle operating space 12 to prompt the hitching portion 23 formed at the distal end of the guide portion 22 to hitch at the handle base 11.

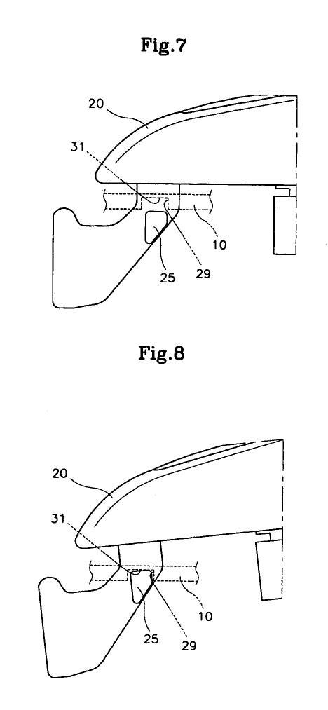

When the door handle 20 is rotated in relation to the handle base 10, the stopper 25 is rotated from a state depicted in FIG. 7 to a state depicted in FIG. 8 and is restricted of its movement by the stopper groove 27 formed in the handle rotating space 11. The stopper 25 prevents the door handle 20 from breaking or detaching to a rotating radial direction of the door handle 20 according to the radial direction restricting portion 29 of the stopper groove 27. The circumferential direction restricting portion 31 restricts the rotating scope of the door handle 20 when the door handle 20 is rotated in excess of a predetermined angle. The restricting functions are also carried out by the guide portion 22 formed at the other distal end of the door handle 20 and the hitching portion 23. In other words, when the door handle 20 is rotated, the movement toward the rotating radial direction of the door handle 20 is restricted by the guide portion 22, and the movement toward the rotating direction of the door handle 20 is limited by the hitching portion 23.

In the outside door handle structure thus described, the movement in relation to the handle base 10 of the door handle 20 is properly restricted at one end of the door handle 20 by the stopper 25 and the stopper groove 27. The movement is restricted at the other end of the door handle 20 by the guide portion 22 and the hitching portion 23, such that the door handle 20 and the handle base 10 are not detached. Therefore, the operation of the door handle is stabilized and the life of the door handle is increased even through frequent repeated usage and excessive manipulations.

As apparent from the foregoing, there is an advantage in the break-prevention structure of an outside door handle in that a pivoting portion functioning as a rotating center of a door handle is prevented from detaching from a handle base by a stopper formed at the rotating portion of the door handle when the door handle is pulled, thus improving the operation and durability of the outside door handle.

1. A break-prevention structure of an outside door handle for vehicles, the structure comprising:
a pivoting portion integrally formed at an end of a door handle, pivotally inserted into a door handle rotating space formed at one end of a handle base and functions as a rotating center of the door handle, and
a guide portion formed at the other end of the door handle and inserted into a handle operating space formed at another end of said handle base, wherein said pivoting portion is formed with a stopper which protrudes toward said handle base in a vertical direction in relation to a rotating surface of the door handle, and said handle rotating space is formed with a stopper groove into which said stopper is inserted.

2. The structure as defined in claim 1, wherein said stopper groove comprises:
a radial direction restricting portion for restricting movement of said stopper to a rotating direction of the door handle; and
a circumferential direction restricting portion for restricting movement of said stopper to a rotating direction of the door handle.

3. The structure as defined in claim 1, wherein two stoppers are disposed, each at an upper surface and a bottom surface of said pivoting portion.
